(19) United States
(12) Patent Application Publication
(10) Pub. No.: US 2016/0072755 A1
(43) Pub. Date: Mar. 10, 2016

(54) SYSTEMS AND METHODS FOR MANAGING A MESSAGE THREAD ON AN ELECTRONIC DEVICE

(71) Applicants: Ray J. SU, Sunnyvale, CA (US); Ryo Misha Urano, Sunnyvale, CA (US); Jonathan Terleski, Mountain View, CA (US)

(72) Inventors: Ray J. SU, Sunnyvale, CA (US); Ryo Misha Urano, Sunnyvale, CA (US); Jonathan Terleski, Mountain View, CA (US)

(73) Assignee: GOOGLE INC., Mountain View, CA (US)

(21) Appl. No.: 13/585,735

(22) Filed: Aug. 14, 2012

(51) Int. Cl. H04L 12/58; G06F 15/16

(52) U.S. Cl. CPC H04L 51/16

(57) ABSTRACT

The subject matter of this specification can be implemented in, among other things, a method that includes receiving a new message and providing instructions to a client device for collapsing at least one of one or more previously received messages when the number of messages reaches a number at which it is desirable to collapse the message thread. The method also includes providing instructions for appending a new message to the message thread. The method may also include instructions for providing one or more collapse or expand controls for managing message threads.

### BACKGROUND

Users of messaging applications can become overwhelmed with the number of messages associated with a particular message thread. For example, in a social networking application, a social stream may display various information posted by users of the social networking application. The social networking application may also allow multiple users to comment on a post by a particular user. If the post is especially popular, users may add many comments to the post, which may result in generating a long comment thread. For example, a long comment thread may comprise tens and even hundreds of comments. Such a long comment thread may render the social stream unwieldy to read and/or scroll through, especially with a real-time implementation of appending messages or comments to a message thread or conversation as they come in.

### SUMMARY

This instant specification relates to messaging applications, particularly to managing message threads for messaging applications.

The disclosed subject matter relates to a machine-implemented method for managing message threads. The method includes receiving a new message for a message thread. A message thread may be comments to a post, an email thread, etc. The method also includes providing instructions to a client device to collapse at least one of one or more previously received messages of the message thread upon the receiving of the new message. In some aspects, the instructions to collapse one or more previously received messages of the message thread are provided when the incoming new message equals a first number (or a collapse-at-number). The first number represents a number at which a user or a message management system desires the message thread to be collapsed at. The method also includes providing instructions to a client device to append the new message to the message thread. Instructions for collapsing and appending of a new message may include instructions for graphically representing the collapsing and/or appending of the messages in a graphical user interface of the client device, providing a visual indication to the user. Other aspects can include corresponding systems, apparatus and computer program products.

These and other aspects can provide one or more of the following features. The first number (or collapse-at-number) may be configured by a user of the message thread system. A new message may be appended at a bottom portion of the thread. The new message may be appended at a top portion of the message thread. The one or more previously received messages may be collapsed graphically to provide a visual indication of the collapsing. One or more previously received messages may be repositioned. The repositioning of the one or more previously received messages may include graphically shifting, up or down, the one or more previously received messages.

The disclosed subject matter relates to a machine-implemented method for managing message threads. The method includes providing instructions to a client device for displaying one or more messages of a message thread in a graphical user interface. The method also includes providing instructions for display of a collapse and/or an expand control. The method also includes instructions for collapsing a plurality of messages of a message thread upon receiving a user action from the collapse control, and for expanding a plurality of messages of a message thread upon receiving a user action from the expand control. Other aspects can include corresponding systems, apparatus and methods.

These and other aspects can provide one or more of the following features. An expand control may be displayed when the message thread has one or more collapsed messages. A collapse control may be displayed when the message thread has one or more expanded messages. The collapse control may be displayed at an end portion of the message thread. In some aspects, previously collapsed unread messages may be expanded in response to a first user action from the expand control and all previously collapsed messages may be expanded in response to a second user action from the expand control.

The disclosed subject matter also relates to a machine-readable medium. The computer-readable medium includes instructions that when executed by a computer, cause the computer to implement a method for managing message threads. The instructions include code for providing instructions to a client device for displaying one or more messages of a message thread in a graphical user interface. A message thread may be comments to a post, an email thread, etc. The instructions also include code for providing instructions to the client device to display a collapse control on the message thread, wherein the collapse control is configured to collapse a plurality of previously expanded messages displayed on the message thread in the graphical user interface in response to a user action from the collapse control. The instructions also include code for providing instructions to the client device to display an expand control on the message thread, wherein the expand control is configured to expand a plurality of previously collapsed messages displayed on the message thread in the graphical user interface in response to a user action from the expand control. Other aspects can include corresponding systems, apparatus and methods.

The disclosed subject matter also relates to a machine-readable medium. The computer-readable medium includes instructions that when executed by a computer, cause the computer to implement a method for managing message threads. The instructions include code for providing instructions to a client device for displaying one or more messages of a message thread in a graphical user interface. The instructions also include code for providing instructions for display of a collapse and/or an expand control. The instructions also include code for collapsing a plurality of messages of a message thread upon receiving a user action from the collapse control, and for expanding a plurality of messages of a message thread upon receiving a user action from the expand control. The instructions may include code for providing instructions for display of the collapse control at an end portion of the message thread. Other aspects can include corresponding systems, apparatus and methods. Other aspects can include corresponding systems, apparatus and methods.

The disclosed subject matter further relates to a system. The system includes one or more processors. The system also includes a memory, the memory having instructions which, when executed by the one or more processors, cause the one or more processors to implement a method for managing message threads. The instructions include code for receiving a new message for a message thread. A message thread may be comments to a post, an email thread, etc. The instructions also include code for providing instructions to a client device to collapse one or more previously received messages of the message thread when the incoming new message equals a first number. The instructions also include code for providing instructions to a client device to append the new message to the message thread. The instructions also include code for providing instructions to display an expand control on the message thread, wherein the expand control is configured to expand a plurality of previously collapsed messages displayed on the message thread in the graphical user interface in response to a user action from the expand control. The instructions may also include code for providing instructions to display a collapse control on the message thread, wherein the collapse control is configured to collapse a plurality of previously expanded messages displayed on the message thread in the graphical user interface in response to a user action from the collapse control. Other aspects can include corresponding systems, apparatus and methods.

These and other embodiments may provide one or more of the following advantages. By automatically collapsing a message thread upon receiving a certain new message, a user will be better able to navigate a social networking page. For example, by collapsing some messages associated with a post, a user may be able to focus on newer messages of a message thread, and may still be able to view other posts. Also, a user may not need to scroll as much to get to various portions of the current message thread or to get to other posts. Furthermore, by providing expand and collapse controls at various points, a user may be able to more easily control the thread size and thereby have better control over viewable portions of a particular thread and other threads. In particular, a collapse control may be positioned at an end portion of the message thread so that the user may conveniently collapse the message thread after the user is done reading through the message thread, without having to scroll to the top of a message thread.

It is understood that other configurations of the subject technology will become readily apparent from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### DESCRIPTION OF DRAWINGS

The features of the subject technology are set forth in the appended claims. However, for purpose of explanation, several aspects of the disclosed subject matter are set forth in the following figures.

FIG. 1 illustrates an example of a system configured for managing message threads.

FIG. 2 illustrates an example of the server of FIG. 1 in more detail.

FIG. 3 illustrates a process for managing message threads.

FIG. 4 illustrates a process for managing message threads.

FIG. 5 is a schematic diagram that shows an example of different states of a system for managing message threads. FIG. 5a-5d illustrate the various collapsed and/or expanded states of a message thread management system.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

The subject technology is related to systems and methods for managing message threads (e.g., comments to a post of social networking application, an email thread in an email management system, etc.) According to certain aspects, when a new message is added to a message thread, one or more of the previous messages will be automatically collapsed, e.g., by hiding the collapsed messages in a certain portion of the message thread. Furthermore, one or more previous messages may be repositioned to allow the new message to be appended to the message thread. One or more previous messages may be automatically collapsed when the number of messages in a message thread reaches a first number or a collapse-at-number, representing the number of messages at which the message thread should be collapsed at. Systems and methods may also provide visual indications to a user of the messaging application about updates to a message thread, e.g., appending a new message graphically, graphically collapsing one or more messages, or graphically expanding one or more messages.

In various aspects, one or more previously received messages of a message thread are collapsed in near real-time upon receiving a new message. For example, as a user is viewing a webpage containing messages (e.g., on a social networking platform, email application, or a blog), and upon the arrival of a new message to be added to the message thread, one or more previously received messages are collapsed on the webpage, without requiring a refresh of the webpage. In some aspects, a user viewing the message thread is provided with a visual indicator that previous messages have been collapsed (e.g., repositioning of messages, addition of the new message and collapsing of previous messages, the addition of an expand control next to the collapsed messages, etc.). The webpage is provided as an example and other graphical user interfaces may be used instead without deviating from the scope of this disclosure.

In various aspects, one or more previously received messages of a message thread are collapsed in near real-time upon receiving of a new message having a certain attribute associated with the new message (e.g., the new message is from a particular source, the new message arrives at a certain timestamp, the new message pertains to certain content, the new message is of a certain size, etc.). In various aspects, one or more previously received messages of a message thread are collapsed upon receiving a new message, where the new message reaches a certain number of messages in the message thread, at which the thread is configured to collapse at.

According to various aspects, the message thread is configurable to be in an expanded state or a collapsed state. The message thread may be collapsed into the collapsed state to hide one or more messages of the message thread, and may be expanded into the expanded state to display one or more messages of the message thread. Graphical user interface (GUI) controls may be provided for a user to easily request collapsing or expansion of parts of a message thread

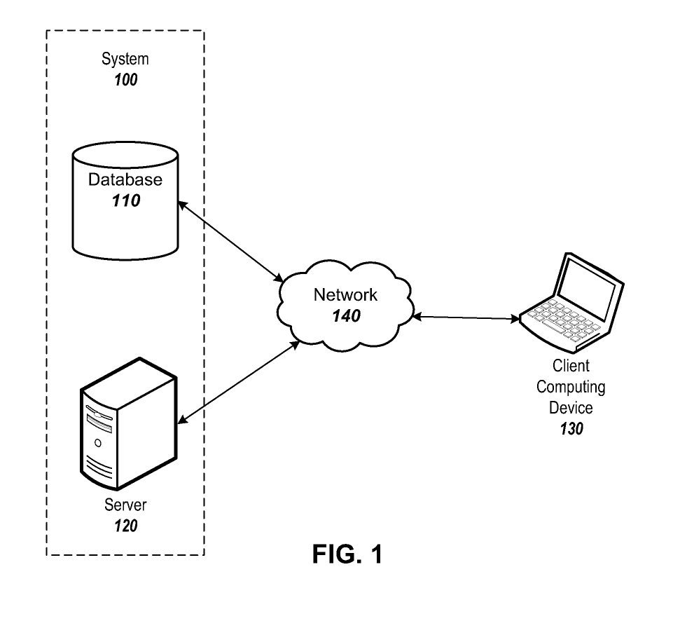

FIG. 1 illustrates an example of a system 100 configured to manage messages of a message thread. As shown, the system 100 includes a data store 110 and a server 120. The data store 110 and the server 120 may be configured to communicate with one another or with a client computing device 130 via a network 140. The network 140 may include the Internet, an intranet, a local area network, a wide area network, a wired network, a wireless network, or a virtual private network (VPN).

The data store 110 may store application and system data (e.g., text, posts, messages, emails, message thread information, configuration parameters, user preferences, message thread management system parameters, etc.) as required by a message thread management system. The data store may include a single machine, multiple machines, a single processor system, or a multi-processor system.

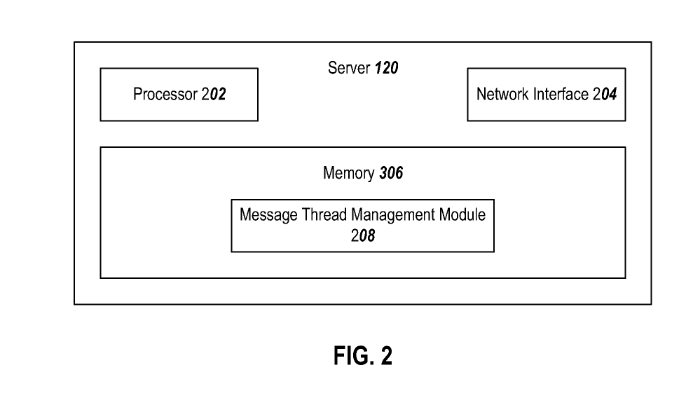

The server 120 may include a module to manage messages of a message thread, messages and posts of which may be stored in the data store 110 or in other machines. The server 120 may be implemented as a single machine with a single processor, a multi-processor machine, or a server farm including multiple machines with multiple processors. One example of the server 120 is described in more detail in conjunction with FIG. 2 below.

The client computing device 130 may be a laptop computer, a desktop computer, a mobile phone, a personal digital assistant (PDA), a tablet computer, a netbook, a television with one or more processors embedded therein or coupled thereto, a physical machine, or a virtual machine. The client computing device 130 may include one or more of a keyboard, a mouse, a display, or a touch screen. The client computing device 130 may also include a web browser configured to display webpages. The web browser may be configured to provide for display of messages of a message thread, for example, by accessing a webpage for viewing messages of a message thread. Alternatively, the client computing device 130 may include an application (e.g., a mobile phone or tablet computer application) for viewing messages of a message thread. While only one client computing device 130 is illustrated in FIG. 1, the subject technology may be implemented in conjunction with one or more client computing devices 130.

FIG. 2 illustrates an example of the server 120 in more detail. As shown, the server 120 includes a processor 202, a network interface 204, and a memory 206. The processor 202 is configured to execute computer instructions that are stored in a computer-readable medium, for example, the memory 206. The processor 202 may be a central processing unit (CPU). While only one processor 202 is illustrated, the server 120 may include multiple processors. Furthermore, while the server 120 is illustrated as a single machine, the server 120 may include multiple machines, e.g., within a server farm. The network interface 204 is configured to allow the server 120 to transmit and receive data in a network, e.g., network 140 of FIG. 1. The network interface 204 may include one or more network interface cards (NICs). The memory 206 may store data or instructions. As illustrated, the memory 206 includes message thread management module 208 within a messaging application, e.g., social networking application, an email application, etc.

The message thread management module 208 is configured to manage messages of a message thread. Message thread management module 208 receives a new message for a post and may forward it to a client computing device 130 of FIG. 1. Message thread management module 208 may store a new message in a data store 110 of FIG. 1 before forwarding the message to client device 130.

In some aspects, message thread management module 208 forwards data associated with a new message to client device 130, triggering client device 130 to execute instructions received from message thread management module 208 for handling of a new message. For example, message thread management module 208 may provide instructions in the form of an HyperText Markup page (HTML) with server-side or client-side JavaScript containing instructions on how to handle a new message. Handling of a new message may include displaying or appending it to a corresponding message thread or post, or collapsing or repositioning of one or more previously received messages of the corresponding message thread.

The instructions, for example in the form of JavaScript, may also provide a number of messages (a first number or a collapse-at-number) for a message thread at which message thread management module 208 is instructing portions of a message thread to be collapsed at, upon receiving of a new message. The instructions may also include a number of messages to collapse for a message thread (collapse-message-number). A collapse-message-number may be indicative of how many message to not collapse (e.g., set to 2 meaning collapse all but 2 messages). Either the HTML or the JavaScript may also contain instructions for displaying one or more collapse or expand controls, for user interaction to request a collapsing or expansion of a portion of a message thread adjacent to a displayed control.

In another aspect, message thread management module 208 takes a new message and stores it on a data store 110 of FIG. 1 and composes a new view to send to client computing device 130. For example, message thread management module 208 may take a new message and reconstruct a new static HTML page to deliver to client computing device 130. A newly constructed HTML page may include required display information for appending a new message to a message thread, or collapsing or repositioning one or more previously received messages. A newly constructed HTML page may also incorporate instructions for displaying one or more collapse or expand controls, for user interaction to request a collapsing or expansion of a portion of a message thread adjacent to a displayed control.

In some aspects, message thread management module 208 provides instructions to a client computing device 130 for updates to a message thread either in near real-time (as near real-time as possible limited by system and network capabilities upon the receiving of a new message), or in a batched fashion (provide updates after receiving two or more new messages) or in some combination thereof. Near real-time updating of message thread display on a graphical user interface at a client device may have the advantage of providing information to a user as it is received. A batched approach may have the advantage of providing certain optimizations of system or network resources (e.g., better us of processing power or bandwidth).

The above described ways of providing a message thread management module are exemplary. HTML and JavaScript implementations are provided as a way of example. Server-side and client-side instructions are provided as a way of example. A message thread management module may be written in a host of languages, in a host of combinations for dividing the work between a server, client, or middle-tier components, without deviating from the scope of this disclosure.

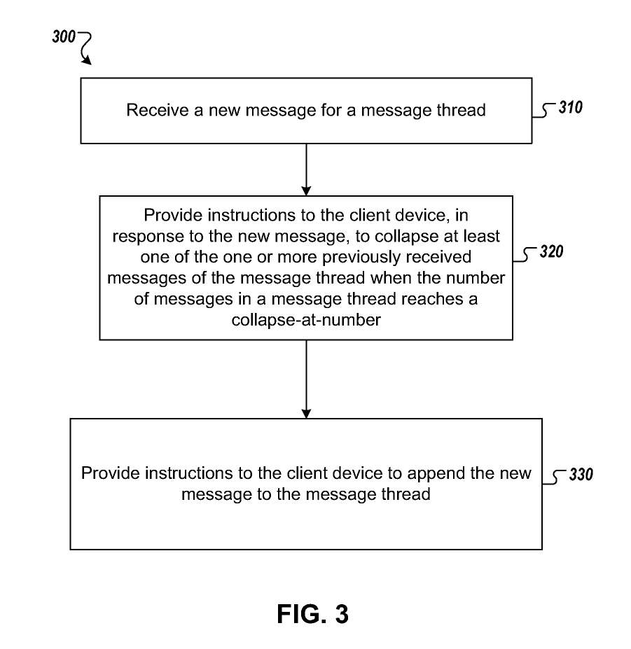

FIG. 3 illustrates an example process 300 by which messages of a message thread may be managed. The process begins at step 310, where a server (e.g., server 120) receives a new message for a message thread. For example, the message thread may be a comment thread (e.g., comments to a post in a social networking system), an email thread, or any other message threads. The messages may be a comment to a post, a reply to an email, a reply to a use group post, etc. The messages may include text, image, or any other graphically or otherwise (audio, etc.) presentable data.

In step 320, the server provides instructions to a client device to automatically collapse one or more messages of the message thread. Collapsing may take place automatically (without user interaction) upon the arrival of a new message. In various aspects, automatic collapsing of messages is provided by maintaining a first number or a collapse-at-number (a number indicative of a user or system desire to collapse messages at for a certain message thread). For example, a message thread may be automatically collapsed upon receiving of a fourth message, when the new message number equals a collapse-at-number set to 4. A check to see if an incoming new message is equal to a collapse-at-number may be performed by a server (e.g., server 120) or by a client (e.g., client computing device 130 by using for example client-side JavaScript) displaying messages of a message thread. One or more previous messages may be repositioned in conjunction with the collapsing of a subset of messages of a message thread. In some aspects, all but a certain number of messages may be collapsed (e.g., collapse all but 2 messages of a message thread).

A user of computing device 130 of FIG. 1 may be able to configure a user preference defining a collapse-at-number for automatically collapsing messages in a message thread (user-configurable). Alternatively, a collapse-at-number may be configured and provided by a message thread management system (system-configurable). A collapse-at-number may vary between users or between various message management systems or between various portions of any given message management system (e.g., automatically collapse comments to post at every 4th message and automatically collapse email replies to an email thread with every 2nd message).

The number of messages to collapse or expand (collapse-message-number or expand-message-number) may be user or system configurable, a default or hard-coded. For example, a parameter specifying a number to collapse or expand may be maintained by a message thread management system. The number specified may be indicative of how many messages to not collapse-message-number set to 2 (e.g., collapse all but two). In some aspects, no collapse-message-number or expand-message-number is provided.

Parameters may be user or system configurable. A collapse-message-number may vary between users or between various message management systems or between various portions of any given message management system (e.g., automatically collapse all but 2 previous comments to a post at every 4th message and automatically collapse the last 4 email replies to an email thread with every 2nd message). The collapse-at-number, collapse-message-number, and expand-message-number may be defaults provided by a system, hard-coded or variable. In some aspects, a message thread management system may not require any of the described numbers. For example, the system may collapse or expand all messages, or all read or unread messages, thereby precluding the need for a collapse-message-number or expand-message-number.

In step 330, the server provides instructions to a client device to append the new message to the message thread. The new message may be appended to the top of the message thread, bottom of the message thread, or somewhere in the middle of the message thread. One or more previous messages may be repositioned to allow the new message to be appended to the message thread. The appended message may include text or other graphical or audio data. The top, bottom or middle of a message thread are exemplary and a new message may be provided at any location and in any manner suitable to a message thread management system without deviating from the scope of this disclosure.

Step 320 may include instructions to graphically represent the corresponding collapsing. For example, the collapsing may be visualized by a user of the device by a subset of messages of the message thread becoming hidden upon the collapsing. A graphical indication may be provided to a user by for example, an expand control showing up next to a collapsed set of messages (indicating a set of messages has been collapsed and may be expanded by activating the expand control by clicking on it). A user of a message thread management system may observe an automatic collapsing by the repositioning of one or more previously received messages of a message thread.

Step 330 may include instructions to graphically represent the appending of the new message. For example, a user of the system may observe the addition of the text of a new message appended to the bottom of the message thread. Alternatively, the user may observe the text of the new message appended at the top of a message thread. A new message may contain data other than text, e.g., image data, or any other graphically representable data.

In order to either collapse as described in step 320, or to append the new message as described in step 330, the system may reposition one or more previously received messages. In some aspects, this may be graphically represented by a shifting of one or more previously received messages. For example, one or more previously received messages may be either graphically shifted down or up from their respective previous locations.

Steps 310, 320, and 330 may either be performed sequentially or simultaneously or partially sequentially and partially simultaneously without deviating from the scope of this disclosure. The steps may be performed in the order illustrated or in any other order combination. Instructions for steps 320 and 330 may be sent by a server to a client device, e.g., in the form of either HTML or HTML/JavaScript combination. In some aspects, steps 310, 320 and 330 of process 300 may lead to the creation of a new HTML page (or any other browser compatible page). For example, the newly generated HTML page may include details necessary to display the message thread with the collapsed messages, in the case where the new message number equaled the collapse-at-number, and to display the newly appended message on the message thread.

Some of the steps described for process 300 may be accomplished by a server (e.g., server 120) module, upon receiving a new message, performing the check for collapse-at-number, updating an HTML page that then is sent by the server to a client device for display. The HTML page may include sufficient details, to display collapsed messages of the message thread where triggered, and to display the appended new message, and where required display of repositioned one or more previously received messages of the message thread.

In another aspect, steps 310, 320, and 330 may cause a server that received a new message for a message thread to communicate the new message to a client device. The receiving client device then has instructions to collapse the message thread if the new message number equals a collapse-at-number. In addition, the receiving client device may have instructions to display the new message, appended to either the top or the bottom of the message thread. The described client-side aspect may be accomplished by, for example, the server providing a JavaScript to the client device (e.g., the browser of the client device), and the JavaScript includes instructions on how to handle a newly incoming message for a message thread. Meaning, the JavaScript at the client side includes rules for when to collapse (e.g., when the new message number equals the defined collapse-at-number) and where to append the new message. The JavaScript may also include rules defined for repositioning previously received messages where required for collapsing or appending of the new message.

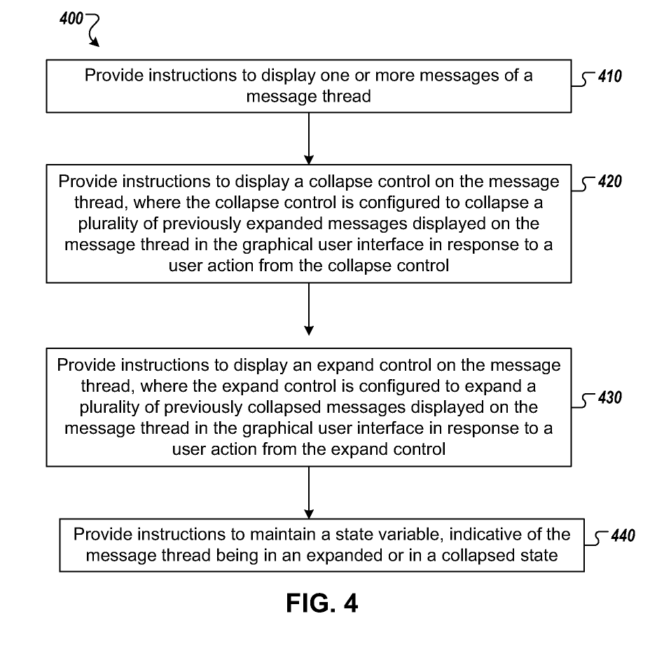

FIG. 4 illustrates an example process 400 by which messages of a message thread may be managed. The process begins at step 410, where a server (e.g., server 120) provides instructions to a client device for displaying of one or more messages of a message thread. At step 420 the server may provide instructions for display of a collapse control on the message thread, and at step 430 the server may provide instructions for display of an expand control on the message thread. Finally, the server at step 440 may provide instructions to maintain information about the state of a message thread, e.g., are portions of the thread in a collapsed or expanded state. In some aspects, the state information may be maintained by maintaining a state variable with information about the current state of an associated portion of the message thread. Steps 410, 420, 430, and 440 of process 400 may be performed sequentially, simultaneously, or partially sequentially and partially simultaneously. The steps may be performed in any order without deviating from the scope of the disclosure.

The message thread may display a collapse control and/or an expand control, at a graphical user interface of a client device, using instructions provided by process 400 at steps 420 and 430. Step 420 may provide instructions for displaying a collapse control upon a user action that expands at least a portion of a message thread. Step 420 may provide for display of a collapse control by detecting that the message thread is in an expanded state (as maintained by instructions provided at step 440). Step 420 may provide instruction for a collapse control to be advantageously displayed on or near an expanded portion of a message thread, enabling a user to more easily instruct the collapsing of that expanded portion of the message thread (e.g., by the user clicking on the collapse control GUI button or control). Step 420 may also provide for display of a collapse control near a bottom portion of a message thread to provide the advantage of a user not having to scroll to the top portion of a message thread in order to collapse it.

Step 430 may provide instructions for displaying of an expand control on a message thread upon the automatic collapsing of at least a portion of a message thread (e.g., when a new message comes in that reaches the collapse-at-number, causing a portion of the messages in the message thread to be collapsed). Step 430 may provide for display of an expand control upon a user action that collapses at least a portion of a message thread. Step 430 may provide for a display of an expand control by detecting that a portion of the message thread is in a collapsed state (as maintained by instructions provided at step 440). An expand control may advantageously be displayed on or near a collapsed portion of a message thread, enabling a user to more easily instruct the expansion of that collapsed portion of the message thread (e.g., by the user clicking on the provided expand control GUI button or control).

Steps 420 and 430 may provide instructions for displaying one or more expand or collapse controls. For example, a message thread may be broken into various segments, each having its own capability for expanding or collapsing, without deviating from the scope of this disclosure. For a particularly long message thread, running over several days (perhaps due to its popularity), the message thread may be broken or organized by day. Messages for each day may have their own associated expand or collapse controls. Organizing of a message thread into several subsets of messages may be based on any criteria other than timeframe without deviating from the scope of this disclosure.

Instructions provided at step 420 and 430 may include taking into account user actions. For example, upon receiving a user action of the provided collapse control at step 420, messages of a message thread may be collapsed. Similarly, upon receiving a user action of the provided expand control at step 430, messages of a message thread may be expanded. Instructions at step 420 and 430 may provide for collapsing or expanding of subset of messages of a message thread. The number of messages to collapse or expand may be user or system configurable. For example, a parameter specifying a maximum number to collapse or expand may be maintained by a message thread management system (collapse-message-number and/or a expand-message-number). Parameters may be user or system configurable.

In some aspects, where a collapse control is displayed near a bottom portion of a message thread, and a user collapses a comment thread by clicking the lower collapse control, the instructions ensure that the bottom of the post remains visible on the screen by scrolling the viewport as appropriate. One advantage is that since there may be many independent conversations or message threads on the user's screen, by maintaining the user's viewport a user may be prevented from being disoriented.

In some aspects, instructions for a two-phase expansion may be provided at step 430. For example, upon receiving a first user action to expand a portion of the message thread, the system may expand those messages in the collapsed portion of the message thread that are unread. Upon receiving a second user action to expand that same portion of the message thread, the system may then expand all messages in the collapsed portion of the message thread. Similar to expansion, a two-phase collapsing may be implemented. For example, upon receiving of a first user action for collapsing a portion of a message thread, only read messages may be collapsed. Upon receiving a second user action to collapse the same portion of the message thread, the system may then collapse all or a maximum number of messages of a message thread.

In another aspect, a two-phase expand experience is provided by instructions that cause only new (unread) comments to be expanded when a user expands a comment thread. In this case the older (previously read) comments may remain collapsed behind another link. A user then may click on the link to see the full thread. One advantage is that users may be able to quickly catch up where they left off in the conversation thread without having to scroll and find where they last read the comment thread.

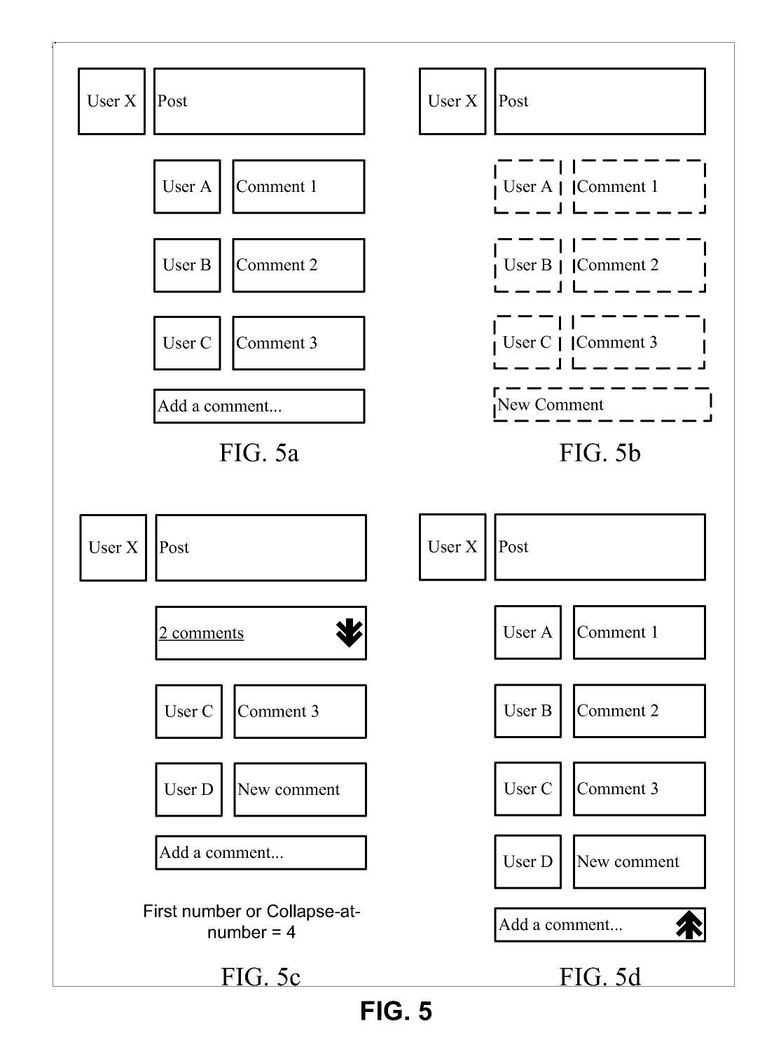

FIG. 5 is a schematic of various graphical representations of user interfaces (UIs) of message threads in a social networking application, where the first number or the collapse-at-number is set to 4. FIG. 5a depicts a post (a message thread) with 3 comments (messages). As illustrated in FIG. 5a the post is displayed with all 3 comments visible on a graphical user interface. FIG. 5a also shows a “Add a comment” input field for a user to provide a new comment for that post. FIG. 5a illustrates the scenario where the number of comments of the post have not reached the first number set to 4. As such, it does not show any collapsed or hidden comments and it does not show any collapse or expand controls. FIG. 5a is illustrative, and it would be possible, for example, to have a collapse control visible somewhere on the message thread to allow a user to collapse the 3 visible comments.

FIG. 5b illustrates a new comment coming in for display on a graphical user interface. It shows that a 4th comment is arriving for display at the graphical interface of a client device. Portions of FIG. 5b are shown using dotted lines because it is a conceptual diagram, representing that a new comment is in the process of being submitted for the post. FIG. 5c shows the results and the schematic updates upon receiving a 4th comment. Since the hypothetical first number is set to 4, as the 4th comment arrives for this post, an automatic collapsing takes place. In this example, the collapsing leads to the hiding of two of the oldest comments in the thread, appending of the new comment to the bottom of the post, and displaying of an expand button on the portion of the thread that was collapsed. In FIG. 5c the message number to collapse is hypothetically set to hide all message except 2 of the newest messages.

FIG. 5d illustrates a user view upon a user of FIG. 5c activating or clicking the provided expand button (for the automatically collapsed comments). As depicted in FIG. 5d, upon a user action asking for expansion of the 2 hidden comments, all 4 comments for the given post are made visible to a user, and a collapse button is displayed at a bottom portion of the thread. Although, not depicted in the various schematics of FIG. 5, upon a user clicking the collapse button provided in FIG. 5d, one or more comments may be hidden, one or more may be visible, and an expand control may be provided somewhere near the collapsed or hidden messages.

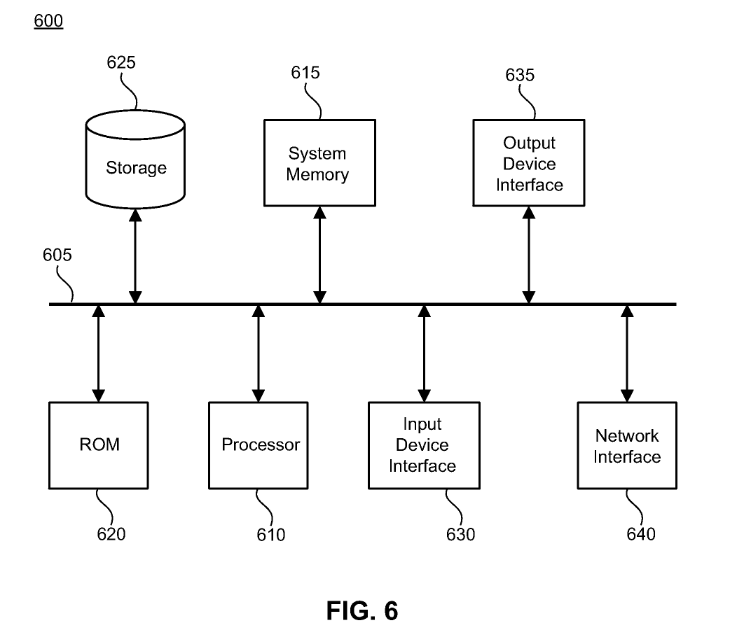

FIG. 6 conceptually illustrates an electronic system 600 with which some implementations of the subject technology are implemented. For example, one or more of the data store 110, the server 120, or the client computing device 130 of FIG. 1 may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for systems and methods for managing message threads on electronic devices in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touchscreen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method, the method comprising:
receiving a new message for a message thread;
providing instructions to a client device to collapse a portion of the message thread in response to the new message, the collapsed portion of the message thread comprising at least one of one or more previously received messages of the message thread displayed in a graphical user interface at the client device;
providing instructions to the client device to append the new message to the message thread for display in the graphical user interface; and
providing instructions to the client device to display a first expand control on the message thread, wherein the first expand control, in response to a first user action from the first expand control, is configured to expand one or more unread messages in the collapsed portion of the message thread and cause display of a second expand control subsequent to the first user action, wherein the second expand control is configured to expand one or more previously read messages in the collapsed portion of the message thread in response to a second user action from the second expand control.

2. The computer-implemented method of claim 1, wherein the instructions to collapse at least one of one or more previously received messages are provided when the number of messages in the message thread reaches a first number.

3. The computer-implemented method of claim 2, wherein the first number is user configurable.

4. The computer-implemented method of claim 1, wherein the new message is appended at a bottom portion of the message thread.

5. The computer-implemented method of claim 1, wherein the new message is appended at a top portion of the message thread.

6. The computer-implemented method of claim 1, wherein the collapsing of the at least one of the one or more previously received messages of the message thread is done graphically, providing visual indication that the one or more previously received messages of the message thread have been collapsed.

7. The computer-implemented method of claim 1, further comprising:
providing instructions to the client device to reposition one or more previously received messages for the message thread displayed in the graphical user interface.

8. The computer-implemented method of claim 7, wherein the instructions for repositioning the one or more previously received messages comprises of instructions for graphically shifting the one or more previously received messages of the message thread on the graphical user-interface.

9. The computer-implemented method of claim 8, wherein the instructions for graphically shifting cause the one or more previously received messages of the message thread to be graphically shifted up on the message thread.

10. The computer-implemented method of claim 8, wherein the instructions for graphically shifting cause the one or more previously received messages of the message thread to be graphically shifted down on the message thread.

11. The computer-implemented method of claim 1, further comprising:
providing instructions to the client device to display a collapse control on the message thread, wherein the collapse control is configured to collapse a plurality of previously expanded messages displayed on the message thread in the graphical user interface in response to a user action from the collapse control.

12. The computer-implemented method of claim 11, wherein at least one of the first and second expand control is displayed when the message thread has one or more collapsed messages.

13. The computer-implemented method of claim 11, wherein the collapse control is displayed when the message thread has one or more expanded messages.

14. The computer-implemented method of claim 11, wherein the collapse control is displayed at an end portion of the message thread.

15. (canceled)

16. A non-transitory computer-readable medium, the non-transitory computer-readable medium comprising instructions that, when executed by a computer, cause the computer to:
provide instructions to a client device to display one or more messages of a message thread in a graphical user interface;
provide instructions to the client device to display a collapse control on the message thread, wherein the collapse control is configured to collapse read messages of previously expanded messages displayed on the message thread in the graphical user interface in response to a first user action from the collapse control, and to collapse one or more unread messages of the previously expanded messages in response to a second user action from the collapse control; and
provide instructions to the client device to display a first expand control on the message thread, wherein the expand control is configured to expand a first plurality of previously collapsed messages displayed on the message thread in the graphical user interface in response to a first user action from the first expand control, the first expand control configured to cause display of a second expand control subsequent to the first user action, the second expand control configured to expand a second plurality of previously collapsed messages displayed on the message thread in the graphical user interface in response to a second user action from the second expand control.

17. A system, the system comprising:
one or more processors;
a memory comprising instructions which, when executed by the one or more processors, cause the one or more processors to:
receive a new message for a message thread;
provide instructions to a client device to collapse, at least one of one or more previously received messages of the message thread displayed in a graphical user interface at the client device when the message thread reaches a first number;
provide instructions to the client device to append the new message to the message thread for display in the graphical user interface; and
provide instructions to the client device to display a first expand control on the message thread, wherein the first expand control is configured to expand unread messages of previously collapsed messages displayed on the message thread in the graphical user interface in response to a first user action from the first expand control, the first expand control configured to cause display of a second expand control subsequent to the first user action to expand one or more read messages of the previously collapsed messages in response to a second user action from the second expand control.

18. The system of claim 17, further comprising instructions which, when executed by the one or more processors, cause the one or more processors to:
provide instructions to the client device to display a collapse control on the message thread, wherein the collapse control is configured to collapse a plurality of previously expanded messages displayed on the message thread in the graphical user interface in response to a user action from the collapse control.

19. The system of claim 18, wherein the instructions to the client device to display the collapse control on the message thread include instructions to display the collapse control at an end portion of the message thread.

20. The system of claim 18, wherein the first user action from the expand control causes all the previously collapsed messages that are unread to be expanded, and wherein the second user action from the expand control causes all the previously collapsed messages to be expanded.
